(19) United States
(12) Patent Application Publication
(10) Pub. No.: US 2015/0283485 A1
(43) Pub. Date: Oct. 8, 2015

(54) FILTER DEVICE AND FILTRATION METHOD

(71) Applicant: BOKELA Ingenieurgesellschaft für Mechanische Verfahrenstechnik mbH, Karlsruhe (DE)

(72) Inventors: Reinhard Bott, Waldbronn (DE); Thomas Langeloh, Muehlhausen (DE)

(73) Assignee: BOKELA Ingenieurgesellschaft für Mechanische Verfahrenstechnik mbH, Karlsruhe (DE)

(21) Appl. No.: 14/663,708

(22) Filed: Mar. 20, 2015

(30) Foreign Application Priority Data
Apr. 3, 2014 (EP) 14 163 350.3

(51) Int. Cl. B01D 33/21; B01D 33/74; B01D 33/82

(52) U.S. Cl. CPC B01D 33/21; B01D 33/82; B01D 33/745

(57) ABSTRACT

The invention relates to a filter device with a base frame, a substantially horizontal, disk-shaped filter pan, which is supported on the base frame such that it can be driven in a rotating manner, has a plurality of disk-segment-shaped filter cells and a pan hub, on which the filter cells are connected to inlet openings of the pan hub in order to drain off filtrate, and a control head which is provided with channels for discharging filtrate from the pan hub, wherein the control head is arranged in a torque-proof and axially movable manner below the pan hub and rests in a sealed manner against an underside of the pan hub. To implement an efficient filtration a pressure housing is provided, which encloses the filter pan and the control head in a pressure-sealed manner. Furthermore, a pressure unit is provided, with which an overpressure can be set in the pressure housing.

The invention relates to a filter device with a base frame, a substantially horizontal, disk-shaped filter pan, which is supported on the base frame such that it can be driven in a rotating manner, has a plurality of disk-segment-shaped filter cells and a pan hub, on which the filter cells are connected to inlet openings of the pan hub in order to drain off filtrate, and a control head which is provided with channels for discharging filtrate from the pan hub, wherein the control head is arranged in a torque-proof and axially movable manner below the pan hub and rests in a sealed manner against an underside of the pan hub, in accordance with the preamble of claim 1.

The invention further relates to a filtration method by making use of such a filter device.

A filter device of such kind is also known as a so-called planar rotary filter or pan filter. The horizontal filter pan is normally designed to take up material to be filtered that accumulates in large quantities so that known planar rotary filters have relatively large diameters. The material to be filtered is normally applied as slurry onto the rotating filter pan, in which case the latter passes through different treatment stations. By way of under-pressure present in the chambers of the filter pan, which is transferred via a stationary control head with corresponding connection openings to a pan hub of the filter pan, liquid is discharged as filtrate from the material to be filtered by means of a filter medium applied to the filter pan.

The dehumidified material to be filtered forms a filter cake which is removed from the filter pan by a removal means at a removal station. Subsequently, in a continuous process induced by the constant rotation of the filter pan the individual filter cell can run through a new treatment cycle.

The invention is based on the object to develop a generic filter device further such that a particularly efficient filtration is practicable.

In accordance with the invention the object is achieved by a filter device having the features of claim 1. Preferred embodiments of the invention are stated in the dependent claims. Furthermore, the invention also provides a filtration method by making use of the filter device according to the invention.

The filter device according to the invention is characterized in that a pressure housing is provided, which encloses the filter pan and the control head in a pressure-sealed manner, and in that a pressure unit is provided, with which an overpressure can be set in the pressure housing.

A fundamental idea of the invention resides in the fact that despite the relatively large dimensions of a filter pan the filter device is provided in its entirety with a pressure housing. Hence, in the pressure housing an overpressure can be set on the filter pan which is higher than the usual atmospheric pressure. As a result, almost any differential pressure can be set efficiently between the upper side of the filter pan and the interior space of the individual filter cells. In the control head, atmospheric pressure, an overpressure that is lower as compared to the overpressure prevailing in the pressure housing or an under-pressure can be present. In particular, the pressure housing thus allows the setting of relatively high pressures preferably ranging from 2 bar to 10 bar, and in single cases even significantly higher, whereby an efficient filtration of the material to be filtered is rendered possible.

A preferred further development of the invention resides in the fact that for individual installation the filter cells are of self-supporting design and fixed on the pan hub in an easily releasable manner. This permits a simplified set-up as well as dismantling for possible maintenance purposes of individual filter cells even though the filter device is enclosed by a pressure-sealed housing.

According to a further development it is particularly preferred that the filter cells are of trough-shaped design and have support profiles along their radial circumferential edge. The support profiles can in particular form a self-supporting fixed support frame, in which the trough-shaped chamber of the filter cell is received. Hence, each filter cell has its own bottom and side walls. An upper side of the trough-shaped, segment-like filter cell is covered by a filter medium in order to form the separating surface. The filter medium can be of any chosen design and is a filter cloth in particular.

A particularly good drainage of filtrate is achieved according to an embodiment pursuant to the invention in that the filter cells have a bottom which is inclined towards the pan hub and which, for the purpose of forming at least one drain groove, has bottom surfaces that are inclined in cross section in the circumferential direction. In this way, one or several drain grooves that are inclined in the radial direction towards the pan hub are formed at the bottom of the trough-shaped filter cell. For an improved discharge of filtrate that can still contain a certain proportion of fine solid matter particles provision can also be made for a flushing means that extends radially from the pan hub inside the chamber-like filter cell.

Known planar rotary filters have a relatively small number of filter cells ranging from six to twelve. An advantageous embodiment of the invention is achieved in that at least 24 filter cells, by preference 36 filter cells, are provided for forming the filter pan. This makes it possible to keep the disk-segment-shaped filter cells very narrow. This permits a simplified handling and in particular a simplified installation or removal of the filter cells from the pressure housing.

According to a further embodiment of the invention it is preferred that the pressure housing has at least one opening which is closable in a pressure-sealed manner and through which individual filter cells can be introduced and removed. By preference, the pressure housing is a steel housing provided with doorways or pressure locks that can be closed in a pressure-sealed manner to prevent pressure losses.

A particularly preferred embodiment resides in the fact that the pressure housing is of approximately cylindrical design with a diameter larger than the filter pan diameter, by preference being up to 20 m or larger, with a drum-shaped circumferential wall, a bottom and a ceiling and that in the bottom and/or the ceiling the opening which is closable in a pressure-sealed manner is arranged. By preference, a door that is closable in a pressure-sealed manner can in particular be provided in the bottom and in the ceiling. This opening is designed such that a single self-supporting filter cell can be transported through the opening into or out of the pressure housing. The individual filter cells are releasably fixed on the pan hub and the surrounding filter cells. In particular, screw connections are provided. Despite a relatively large diameter of the filter pan the self-supporting design of the filter cells permits a partial dismantling of the filter pan without this collapsing with its remaining components.

According to an embodiment an especially efficient construction results from the fact that the filter pan is formed as a spoke wheel with a frame consisting of spokes and a circumferential ring, wherein the filter cells are inserted as circular disk segments.

An especially compact arrangement of the filter device is achieved in accordance with the invention in that the base frame is of ring-shaped design and that the filter pan is supported in a rotatable manner on the base frame by way of an axial bearing means. Thus, the base frame and the axial bearing means take up the considerable axial load that the filter pan has to carry during operation. The axial bearing means can be an axial roller bearing in particular.

A further preferred embodiment of the invention resides in the fact that the control head is arranged within a ring-shaped base frame and has a plate-shaped upper side which rests in a sealed manner against a corresponding plate-shaped underside of the pan hub. The control head is arranged in a torque-proof manner with respect to the rotatable pan hub and the filter pan. The upper side of the control head and the underside of the pan hub are of corresponding and in particular planar design in order to form a large sealing surface. Along this sealing surface the connection openings for the channels leading from the control head to the pan hub are also arranged. These channels especially serve to discharge filtrate from the individual filter cells according to the respective rotational position of the filter pan and also to supply e.g. compressed air in order that a base layer remaining on the filter medium is removed, in particular blown off from below. In addition to an application station for applying the material to be filtered, the removal station for discharging the filter cake and the one or several dehumidifying stations further treatment stations, such as a steam treatment station etc. can be provided in a known manner along the circulation path of the filter pan.

According to a further embodiment of the invention provision is made for the overpressure in the pressure housing to be set such that due to the pressure difference between the pressure in the pressure housing and the pressure in the interior of the control head the said control head is pressed axially against the underside of the pan hub. By preference, for the discharge of the filtrate atmospheric pressure is present in the interior of the control head so that the filtrate can be easily discharged from the control head and the pressure housing and processed further. In certain cases, however, an additional under-pressure can also be set inside the control head, whereby the pressure differential and therefore the filtration rate would increase further. In any case, a pressure difference is present between the interior of the control head and the exterior, through which the control head is pressed axially upwards against the underside of the pan hub. The control head is preferably provided with radial flange surfaces so that a corresponding contact pressure can develop.

In case of interruption of operation along with a drop of overpressure it is of advantage in accordance with a further development of the invention that a pressing means is provided, through which the control head is pressed against the pan hub or the pan hub against the control head in order to ensure a minimum contact pressure. In particular, the pressing means can have compression springs or also pressing cylinders, by means of which the control head is pressed axially upwards against the pan hub or the pan hub is pressed axially downwards against the control head. The pressing means is preferably arranged between the control head and a base plate or the base frame.

According to a further embodiment of the invention it is of advantage that a counter-pressure means is provided, through which a counterforce can be applied to the control head in order to reduce a contact force acting on the control head. If a relatively high overpressure is set a very high contact force can develop that presses the stationary control head against the rotating pan hub. To prevent unnecessary friction losses the counter-pressure means provided according to the invention makes it possible to apply a counterforce to the control head, through which the contact force is reduced and compensated in the desired way. Thereby, the contact force can be reduced to such an extent that it is sufficiently high to provide adequate tightness whilst preventing excessive friction losses.

As a preferred embodiment of the invention provision can be made for the counter-pressure means to have a hydrostatic pressure means which is arranged between the pan hub and the control head. On the contact surfaces between the stationary control head and the rotating pan hub pocket-shaped recesses can be provided that are acted upon by a pressure fluid via fluid channels. The fluid can be a gas or a liquid, in particular a hydraulic liquid. By means of a corresponding control means the pressure of the counter-pressure means can be set in the desired way. Thereby, the hydrostatic pressure means has the additional advantage that besides pressure compensation it can also bring about a certain reduction of friction.

According to a further embodiment of the invention another possibility of generating the counter-pressure resides in the fact that the counter-pressure means comprises at least one positioning cylinder, in particular a hydraulic cylinder. The preferably several positioning cylinders are evenly arranged on the circumference of the tubular control head and connected to a base plate or the base frame. The positioning cylinders can thus pull the control head contrary to the contact force in the axial downward direction towards the base plate and thereby effect a compensation of the contact force.

In accordance with the invention provision is also made for a filtration method which is carried out with one of the previously described filter devices. The filtration method according to the invention is characterized in that by means of a pressure unit an over-pressure is set in the pressure housing. By way of the filtration method the advantages set out beforehand can be attained.

The invention will be described further hereinafter by way of preferred exemplary embodiments illustrated schematically in the accompanying drawings, wherein show:

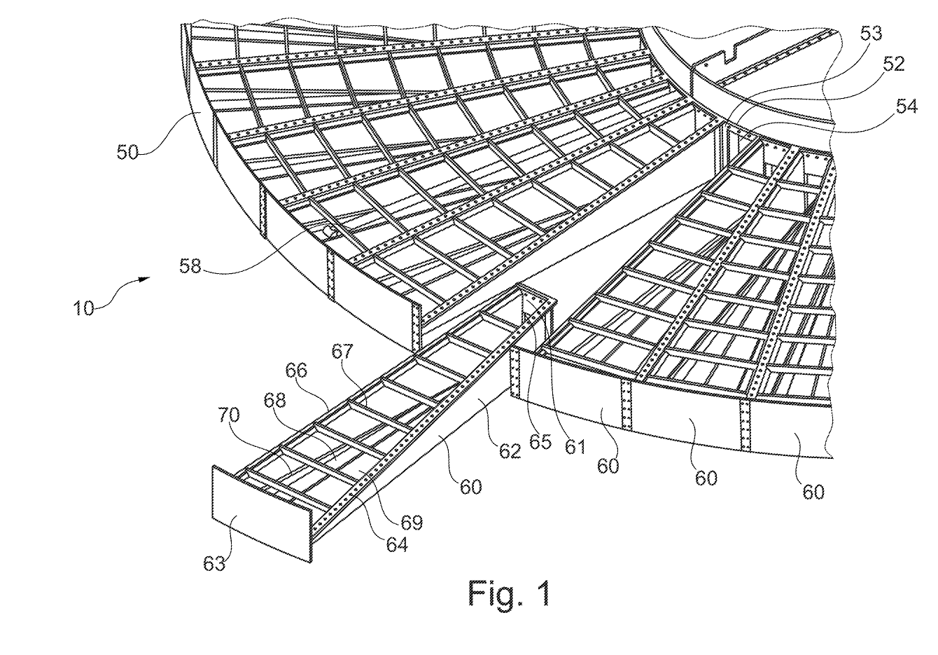

FIG. 1 a perspective partial view of a filter pan according to the invention;

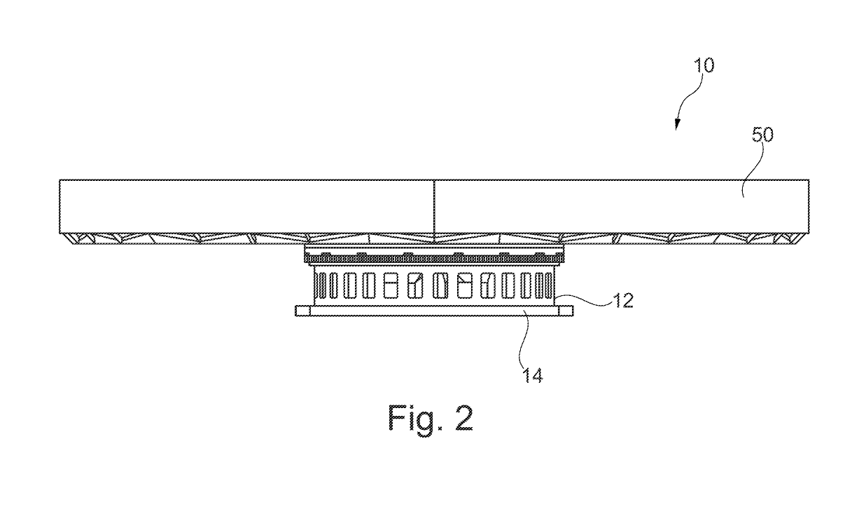

FIG. 2 a side view of the filter pan of a filter device according to the invention;

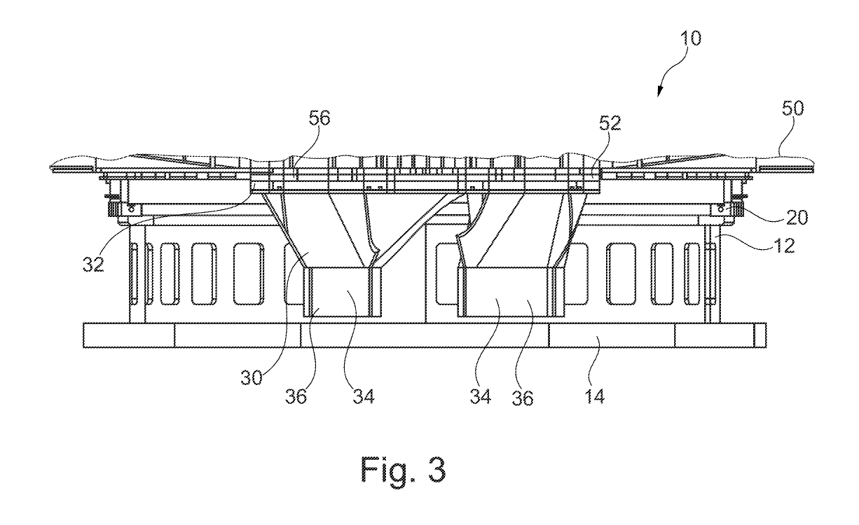

FIG. 3 an enlarged partial cross-sectional view of the base frame of a first filter device according to the invention;

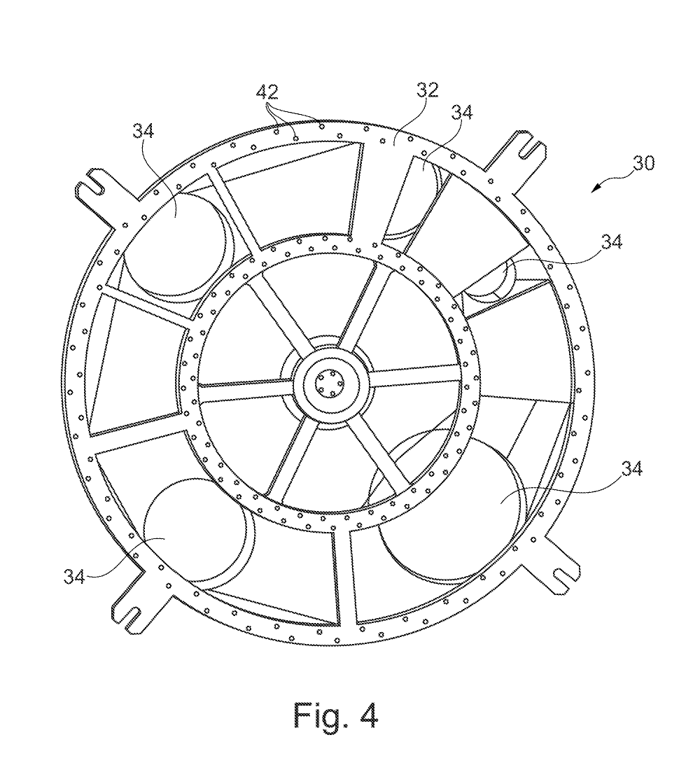

FIG. 4 a plan view of the control head according to the filter device of FIG. 3;

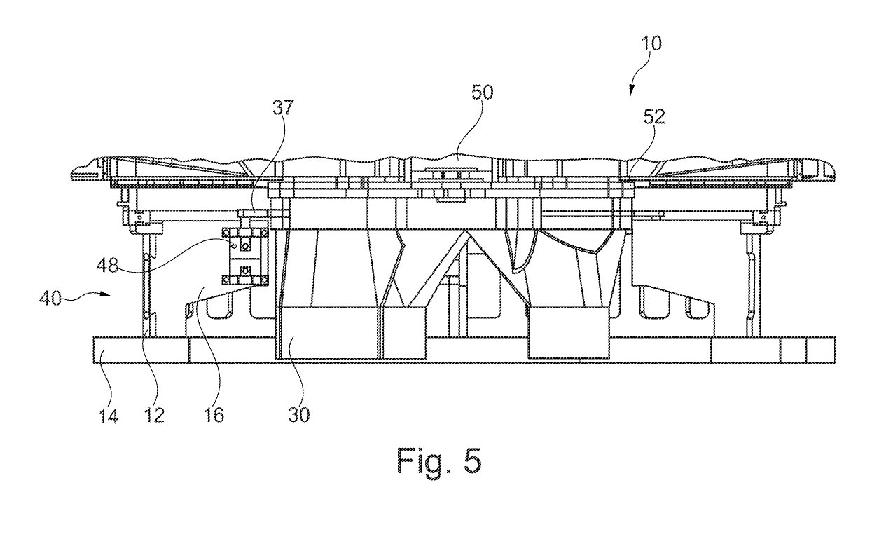

FIG. 5 a partial cross-sectional view of the base frame of a second filter device according to the invention; and

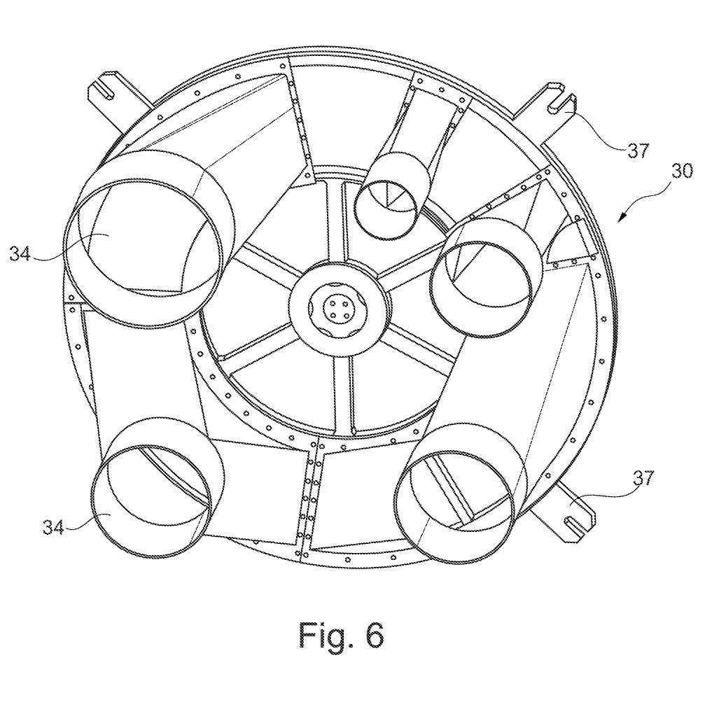

FIG. 6 a perspective view from below of a control head of the filter device according to FIG. 5.

A filter pan 50 of a filter device 10 according to the invention is illustrated in FIG. 1. The filter pan 50 has a plurality of disk-segment-like or cake-piece-shaped filter cells 60. In the illustrated exemplary embodiment the filter pan 50 is composed of a total of 36 filter cells which each form an angular segment of 10° and are fixed on a central pan hub.

A single filter cell 60 has a trough 62 formed of sheet metal which is provided with a rear wall 63 on its radially outward facing side. Along the radial upper edge support profiles 64 are provided that form a support frame 66 together with cross members 67. On the underside of this support frame 66 the trough 62 made of sheet metal is fixed. In addition to lateral surfaces the trough 62 has a bottom 68 which is inclined radially inwards so as to enable drainage of the filtrate towards the central pan hub 52. The bottom 68 itself is composed of inclined bottom surfaces 69, whereby radially directed drain grooves 70 are formed.

A radially inward directed face side 61 of the filter cell 60 is designed as a fixing area. By way of screw connections, not depicted, the filter cell 60 can be releasably fixed with the fixing area at the face side 61 on a connecting flange 53 located on the exterior of the drum-shaped pan hub 52. The ring-shaped connecting flange 53 encloses an inlet opening 54. In the fixed state, filtrate can flow via a passage 65 in the face side 61 of the filter cell 60 through the inlet opening 54 into the cylindrical pan hub 52.

On the upper side of a filter cell 60 a filter medium, in particular a filter cloth, not shown, is stretched on the support frame 66. Due to the pressure differential applied during the filtration method a solid matter or filter cake is formed on the filter medium while liquid is led away from the material to be filtered towards the interior of a filter cell 60 and drained inwards to the pan hub 52.

Each filter cell 60 is designed as a self-supporting element which is screwed via the face side 61 to the pan hub 52 and via corresponding screw connections disposed along the radial support profiles 64 to the respective adjoining filter cells 60. Through a suitable release of the connecting means an individual filter cell 60 or several filter cells 60 can be released from the filter pan 50 for maintenance purposes for example. Through an opening located in the non-depicted container-shaped pressure housing, which encloses the filter pan 50 and the respective treatment stations on the filter pan 50 in a pressure-sealed manner, individual filter cells 60 can be introduced and removed.

A side view of the filter device according to the invention is shown in FIG. 2. The horizontal filter pan 50 is supported in a rotatable manner about a vertical axis of rotation on a drum-shaped base frame 12 with a horizontal bottom plate 14. Along the upper side of the filter pan 50 various treatment stations are located in a known manner, in particular an application station for applying the material to be filtered, one or several dehumidifying stations, in which the actual filtering process is carried out on the basis of the applied pressure differential, and a removal station for removing the residual solid matter or filter cake from the upper side of the filter medium of the filter pan 50 and for discharging it from the pressure housing, not depicted. In the pressure housing an over-pressure is set by a pressure unit, more particularly a known compressor. The over-pressure, which amounts to several bar, expels humidity from the bulk of the applied material to be filtered through the filter medium into the hollow chambers of the individual filter cells 60, from which the filtrate is drained off via the pan hub to a control head 30.

A control head 30 is illustrated in greater detail in FIG. 3. The control head 30 has a plate-shaped upper side 32 which rests in a sealed manner against a corresponding plate-shaped underside 56 of the pan hub 52 of the filter pan 50. While the filter pan 50 is driven in a rotating manner about a vertical axis of rotation by a rotary drive not shown, the control head 30 as well as the base frame 12 are non-rotating. By way of a ring-shaped axial bearing means 20 the filter pan 50 is axially stabilized and rotatably supported on the drum-shaped base frame 12. The base frame 12 is firmly connected to a bottom plate 14 which is also arranged inside the pressure housing, not depicted.

The control head 30 is connected in a torque-proof manner to the base frame 12 and therefore does not co-rotate with the filter pan 50. The control head 30 is provided with a plurality of channels 34 for draining off filtrate from the pan hub 52 through suitable passage openings. The control head 30 is supported in an axially movable manner with respect to the pan hub 52. For this purpose, the lower drain fittings 36 on the channels 34 of the control head 30 are connected via flexible hose connections or metal bellow expansion joints to drain lines, not depicted, that lead to the exterior of the pressure housing.

By preference, atmospheric pressure is present inside the control head 30 so that due to the overpressure in the pressure housing the control head 30 is pressed in a sealed manner with its upper side 32 against the corresponding underside 56 of the pan hub 52. As a result, the interior space in the control head 30 is closed in a pressured-sealed manner with respect to the exterior space in the pressure housing.

Due to the overpressure in the non-depicted pressure housing the contact force acting on the control head 30 can be of such intensity that the rotary motion of the filter pan 50 can give rise to excessive friction in the area of the contact surface between the upper side 32 of the control head 30 and the underside 56 of the pan hub 52.

In the embodiment of the filter device 10 shown in FIG. 3 a counter-pressure means 40 is provided in the frictional contact area, which is illustrated and described in greater detail in conjunction with FIG. 4. To generate a counter-pressure a plurality of disk-shaped and groove-shaped recesses 42 are introduced along the upper side 32 of the control head 30 in the contact surface to the pan hub 52, which are connected via channels, not depicted, to a hydraulic pump of the counter-pressure means 40. By way of the pump hydraulic pressure can be built up between the upper side 32 of the control head 30 and the underside 56 of the pan hub 52, which counteracts an axial contact force of the control head 30 as a result of the external overpressure. In this embodiment the hydrostatic generation of a counter-pressure in the ring-shaped contact areas between control head 30 and pan hub 52 also has a friction-reducing effect.

According to FIGS. 5 and 6 a further, second embodiment of a filter device 10 pursuant to the invention is shown, in which a modified counter-pressure means 40 is designed. In the case of this counter-pressure means 40 several positioning cylinders 48 are arranged by being distributed in a ring-shaped manner about the control head 30. Here, a positioning cylinder 48 is connected on its upper side to radial retaining brackets 37 of the control head 30. A lower part of the positioning cylinder 48 is firmly connected via bar-shaped supports 16 to the base frame 12 and the bottom plate 14. By way of a control means the hydraulic positioning cylinders 48 can be set such that they pull the control head 30 axially downwards contrary to the upward-directed axial contact force, whereby the contact force is reduced and compensated to the extent desired. By way of the counter-pressure means 40 the filter device 10 according to the invention can be operated with a horizontally directed rotating filter pan 50 in a pressure housing with overpressure. In the event of failure of overpressure the positioning cylinders 48 can also serve to ensure a necessary minimum contact force of the control head 30 onto the pan hub 52.

1. Filter device with
a base frame,
a substantially horizontal, disk-shaped filter pan,
which
is supported on the base frame such that it can be driven in a rotating manner,
has a plurality of disk-segment-shaped filter cells and
a pan hub, on which the filter cells are connected to inlet openings of the pan hub in order to drain off filtrate,
and
a control head which is provided with channels for discharging filtrate from the pan hub, wherein the control head is arranged in a torque-proof and axially movable manner below the pan hub and rests in a sealed manner against an underside of the pan hub,
wherein
a pressure housing is provided, which encloses the filter pan and the control head in a pressure-sealed manner, and
a pressure unit is provided, with which an overpressure can be set in the pressure housing.

2. Filter device according to claim 1,
wherein
for individual installation the filter cells are of self-supporting design and fixed on the pan hub in an easily releasable manner.

3. Filter device according to claim 1,
wherein
the filter cells are of trough-shaped design and have support profiles along their upper radial circumferential edge.

4. Filter device according to claim 1,
wherein
the filter cells have a bottom which is inclined towards the pan hub and which, for the purpose of forming at least one drain groove, has bottom surfaces that are inclined in cross section in the circumferential direction.

5. Filter device according to claim 1,
wherein
at least 24 filter cells, by preference 36 filter cells, are provided for forming the filter pan.

6. Filter device according to claim 1,
wherein
the pressure housing has at least one opening which is closable in a pressure-sealed manner and through which individual filter cells can be introduced and removed.

7. Filter device according to claim 6,
wherein
the pressure housing is of approximately cylindrical design, with a drum-shaped circumferential wall, a bottom and a ceiling, and
in the bottom and/or the ceiling the opening which is closable in a pressure-sealed manner is arranged.

8. Filter device according to claim 1,
wherein
the filter pan is formed as a spoke wheel with a frame consisting of spokes and a circumferential ring, wherein the filter cells are inserted as circular disk segments.

9. Filter device according to claim 1,
wherein
the control head is arranged within a ring-shaped base frame and has a plate-shaped upper side which rests in a sealed manner against a corresponding plate-shaped underside of the pan hub.

10. Filter device according to claim 1,
wherein
the overpressure in the pressure housing is set such that the control head is pressed axially against the underside of the pan hub.

11. Filter device according to claim 1,
wherein
a pressing means is provided, through which the control head is pressed against the pan hub in order to ensure a minimum contact pressure.

12. Filter device according to claim 10,
wherein
a counter-pressure means is provided, through which a counterforce can be applied to the control head in order to reduce a contact force acting on the control head.

13. Filter device according to claim 12,
wherein
the counter-pressure means has a hydrostatic pressure means which is arranged between the pan hub and the control head.

14. Filter device according to claim 12,
wherein
the counter-pressure means comprises at least one positioning cylinder, in particular a hydraulic cylinder.

15. Filtration method carried out with a filter device according to claim 1,
wherein
by means of a pressure unit an overpressure is set in the pressure housing.
